(19) United States
(12) Patent Application Publication
(10) Pub. No.: US 2025/0016294 A1
(43) Pub. Date: Jan. 9, 2025

(54) MAINTENANCE METHOD

(71) Applicant: Panasonic Intellectual Property Management Co., Ltd., Osaka (JP)

(72) Inventors: Shinji KAWASAKI, Osaka (JP); Toru ANDO, Osaka (JP); Keiji MAEDA, Kyoto (JP); Takeshi NAKAYAMA, Osaka (JP); Daisuke YAEO, Osaka (JP)

(21) Appl. No.: 18/896,029

(22) Filed: Sep. 25, 2024

Related U.S. Application Data
(63) Continuation of application No. PCT/JP2023/011227, filed on Mar. 22, 2023.

(30) Foreign Application Priority Data
Mar. 30, 2022 (JP) 2022-055853

(51) Int. Cl. H04N 9/31; G03B 21/20

(52) U.S. Cl. CPC H04N 9/3191; G03B 21/2053

(57) ABSTRACT

A maintenance method for a device including a light source, the maintenance method including: (a) a step of predicting timing for maintenance for the device based on at least one of a temporal change in an output of the light source or a usage condition of the device; (b) a step of detecting luminance of light output from the light source; and (c) a step of updating the timing for maintenance predicted in (a), based on a detection result in (b).

### CROSS-REFERENCE OF RELATED APPLICATIONS

This application is a Continuation of International Patent Application No. PCT/JP2023/011227, filed on Mar. 22, 2023, which in turn claims the benefit of Japanese Patent Application No. 2022-055853, filed on Mar. 30, 2022, the entire disclosure of which applications are incorporated by reference herein.

### BACKGROUND

### 1. Technical Field

The present disclosure relates to a maintenance method for a device including a light source.

### 2. Description of the Related Art

Maintenance methods for a device including a light source have been known. The maintenance method disclosed in Patent Literature (PTL) 1 makes a prediction (calculation) of the timing for maintaining a light source by comparing a standard value of temporal variation in the absorbance of the light source, with an actual measurement.

PTL 1: Unexamined Japanese Patent Publication No. 2011-117746

### SUMMARY

However, in the conventional maintenance method described above, there is some room for improvement in the accuracy in the prediction of the timing for maintenance.

The present disclosure provides a maintenance method capable of improving the accuracy in the prediction of the timing for maintenance.

A maintenance method according to the present disclosure is a maintenance method for a device including a light source, the maintenance method including: (a) a step of predicting timing for maintenance for the device based on at least one of a temporal change in an output of the light source or a usage condition of the device; (b) a step of detecting luminance of light output from the light source; and (c) a step of updating the timing for maintenance predicted in (a), based on a detection result in (b).

With the maintenance method according to the present disclosure, it is possible to improve the accuracy in the prediction of the timing for maintenance.

### BRIEF DESCRIPTION OF THE DRAWINGS

FIG. 1 is a block diagram illustrating a configuration of a maintenance system according to an exemplary embodiment.

FIG. 2 is a diagram for explaining a first mode of a projector.

FIG. 3 is a diagram for explaining a second mode of the projector.

FIG. 4 is a sequence chart illustrating the sequence of an operation of the maintenance system according to the exemplary embodiment.

FIG. 5 is a diagram for describing a method of predicting the lifetime of a light source unit, in the first mode.

FIG. 6 is a diagram for describing a method of predicting the lifetime of the light source unit, in the second mode.

FIG. 7 is a diagram illustrating an example of a summary file.

FIG. 8 is a diagram illustrating an example of an individual file.

### DETAILED DESCRIPTION

An exemplary embodiment will now be described in detail with reference to some drawings as appropriate. Note that descriptions more in detail than necessary are sometimes omitted. For example, detailed descriptions of already well-known matters and redundant descriptions of substantially identical configurations are sometimes omitted. This is to avoid unnecessary redundancy in the description below, and to facilitate understanding of those skilled in the art.

Note that the inventor of the present disclosure provides the accompanying drawings and the following description for the purpose of enabling those skilled in the art to fully understand the present disclosure, and therefore, the accompanying drawings and the following description are not intended to limit the subject matter as defined in the appended claims, in any way.

### Exemplary Embodiment

### 1. Configuration of Maintenance System

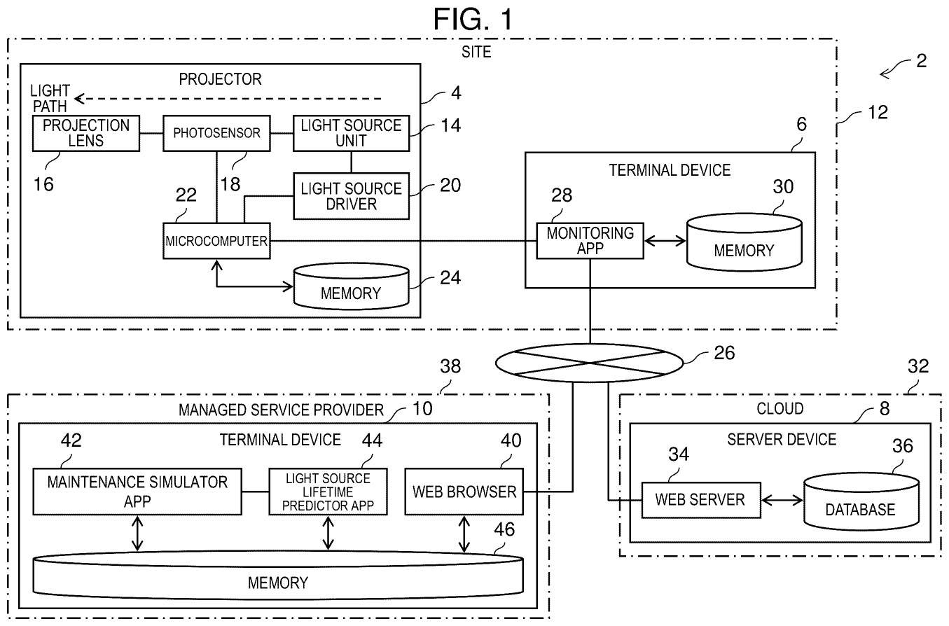

To begin with, a configuration of maintenance system 2 according to the exemplary embodiment will now be described with reference to FIG. 1. FIG. 1 is a block diagram illustrating a configuration of maintenance system 2 according to the exemplary embodiment.

As illustrated in FIG. 1, maintenance system 2 includes projector 4 (an example of a device), terminal device 6, server device 8, and terminal device 10. Note that, for the convenience of description, only one projector 4 is illustrated in FIG. 1, but maintenance system 2 actually includes a plurality of projectors 4.

Projector 4 is installed on site 12, such as a museum or an amusement park, for example, and projects light that represents an image (e.g., an image for explaining an exhibition) on a projection surface such as a screen. Projector 4 is capable of communicating with terminal device 6 over a network (not illustrated), and is used by a user who is a customer of managed service provider 38, to be described later. Projector 4 includes light source unit 14 (an example of a light source), projection lens 16, photosensor 18, light source driver 20 (an example of the light source), microcomputer 22, and memory 24.

Light source unit 14 outputs light representing an image. Although not illustrated, light source unit 14 includes: an illumination optical system including a laser diode such as a blue laser diode, a condenser lens, and a dichroic mirror; and an image display element such as a digital mirror device (DMD) or a liquid crystal display element, for example.

The light output from light source unit 14 becomes incident on projection lens 16. Projection lens 16 magnifies and projects the incident light onto the projection surface. Although not illustrated, a phosphor wheel is disposed on the light path between light source unit 14 and projection lens 16. The phosphor wheel is for converting the blue light output from the blue laser diode included in light source unit 14 into yellow light, using fluorescence excitation.

Photosensor 18 is disposed on the light path between light source unit 14 and projection lens 16, and detects the luminance of the light output from light source unit 14. The luminance detected by photosensor 18 is represented by a numerical value between 0% and 100%, for example.

Light source driver 20 controls driving of the laser diode included in light source unit 14. The laser diode in the light source unit 14 is controlled to turn ON and OFF, on the basis of a voltage or a current output from light source driver 20. In the description herein, the output from light source driver 20 means a voltage or a current output from light source driver 20 and input to the laser diode in light source unit 14. The voltage and the current input to light source unit 14 are controlled using a numerical value between 0% to 100%, for example.

Microcomputer 22 acquires a photosensor log once in every predetermined time interval. The photosensor log is a piece of data representing the luminance detected by photosensor 18. Microcomputer 22 also acquires a light source control log once in every predetermined time interval. The light source control log is a piece of data representing the output of the light source driver 20. Microcomputer 22 transmits the acquired photosensor log and light source control log to terminal device 6 over the network, and stores the photosensor log and the light source control log in memory 24.

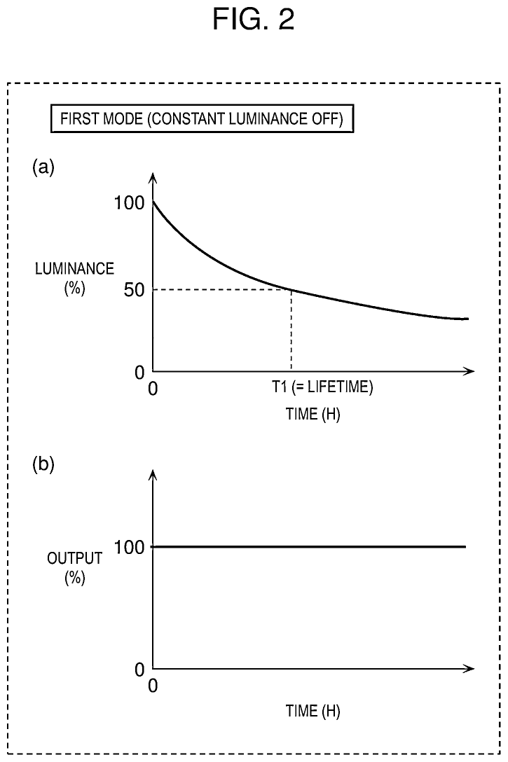

An operation mode of projector 4 described above is switchable between a first mode and a second mode. The first mode will now be described with reference to FIG. 2. Part (a) of FIG. 2 is a graph indicating a temporal change in the luminance of the light from light source unit 14 in the first mode; and part (b) of FIG. 2 is a graph indicating a temporal change in the output of light source driver 20 in the first mode.

The first mode is a mode for controlling light source driver 20 so as to keep the output of light source driver 20 constant. In the first mode, although the output of light source driver 20 is kept constant at 100%, as an example, as illustrated in part (b) of FIG. 2, the luminance of the light from light source unit 14 gradually decreases from 100%, for example, as illustrated in part (a) of FIG. 2, due to the aging of light source unit 14. Under such a condition, the luminance maintenance factor gradually drops from 100%. The luminance maintenance factor herein is a ratio of the luminance of the light output from light source unit 14 upon expiry of a predetermined time period from a particular timing (e.g., the timing of factory shipment of projector 4), with respect to the luminance of the light output from light source unit 14 at the particular timing, given that the output from light source driver 20 is kept constant. In the first mode, time T1 at which the luminance of the light output from light source unit 14 drops to 50%, as indicated in part (a) of FIG. 2, is determined as the end of the lifetime of light source unit 14. Note that the luminance maintenance factor for determining that light source unit 14 has reached the end of lifetime may be set to any numerical value, without limitation to 50%.

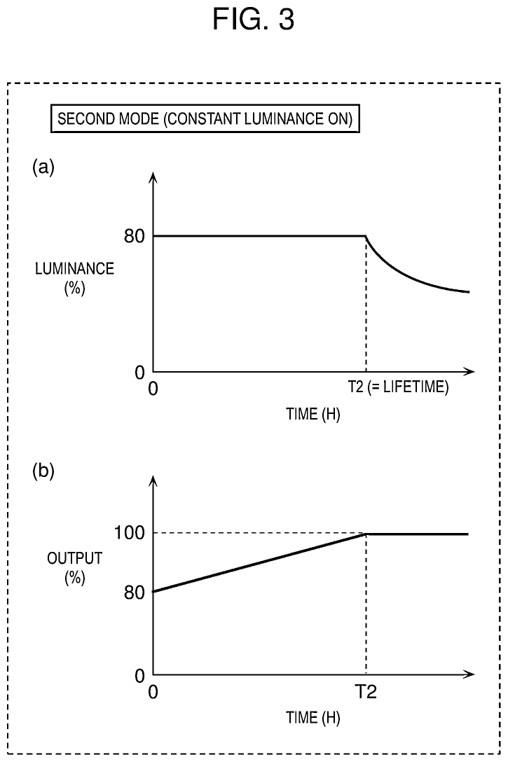

The second mode will now be described with reference to FIG. 3. Part (a) of FIG. 3 is a graph indicating a temporal change in the luminance of the light from light source unit 14 in the second mode; and part (b) of FIG. 3 is a graph indicating a temporal change in the output of light source driver 20 in the second mode.

The second mode is a mode for controlling light source driver 20 so as to keep the luminance of the light output from light source unit 14 constant. In the second mode, by gradually increasing the output of light source driver 20 from 80%, for example, as indicated in part (b) of FIG. 3, the luminance of the light from light source unit 14 is kept constant at 80%, for example, as illustrated in part (a) of FIG. 3. Under such a condition, the luminance maintenance factor gradually drops from 100%. When the output of light source driver 20 hits 100% at time T2, as illustrated in part (b) of FIG. 3, for example, the output of light source driver 20 cannot be increased any further. Therefore, after time T2, the output of light source driver 20 is kept constant at 100%. As a result, the luminance of the light output from light source unit 14 starts falling from 80% at time T2, as illustrated in part (a) of FIG. 3. In the second mode, the time T2 is determined as the end of the lifetime of light source unit 14.

Returning to FIG. 1, terminal device 6 is a personal computer, for example, and is installed, with projector 4, on site 12. Terminal device 6 is capable of communicating with projector 4 over the network, and of communicating with server device 8 via internet 26. Terminal device 6 includes monitoring application 28 (hereinafter referred to as “monitoring app 28”) and memory 30.

Monitoring app 28 is an application for monitoring projector 4, and receives the photosensor log and the light source control log from projector 4. Monitoring app 28 uploads the received photosensor log and light source control log onto server device 8 via internet 26, and stores the same received photosensor log and light source control log in memory 30.

Server device 8 is installed in cloud 32. Server device 8 includes web server 34 and database 36. Server device 8 is capable of communicating with each of terminal device 6 and terminal device 10 via internet 26.

Web server 34 receives the photosensor log and the light source control log from terminal device 6. Web server 34 stores the received photosensor log and light source control log in database 36. Database 36 stores therein the photosensor log and the light source control log for each of projectors 4.

Terminal device 10 is a personal computer, for example, and is installed in managed service provider 38 at a remote location from site 12. Managed service provider 38 is a company that creates a maintenance plan for projectors 4 by managing projectors 4.

Terminal device 10 is capable of communicating with server device 8 via internet 26. Terminal device 10 includes web browser 40, maintenance simulator application 42 (hereinafter, referred to as “maintenance simulator app 42”), light source lifetime predictor application 44 (hereinafter, referred to as a “light source lifetime predictor app 44”), and memory 46.

Web browser 40 downloads the photosensor log and the light source control log from server device 8, via internet 26. Web browser 40 stores downloaded photosensor log and light source control log in memory 46.

Maintenance simulator app 42 predicts timing for maintenance of projector 4 (e.g., timing for replacing light source unit 14), by running a simulation on the basis of at least one of a temporal change in the output of light source unit 14 or a usage condition of projector 4, entered by an employee or the like of managed service provider 38. In the description herein, the temporal change in the output of light source unit 14 means a deterioration curve of the luminance of the light output from light source unit 14, for example. The usage condition of projector 4 includes unique conditions including time of usage and the luminance setting of projector 4, and external conditions such as dust and ambient temperature attributable to the environment where projector 4 is used.

Maintenance simulator app 42 updates the predicted timing for maintenance, on the basis of light source lifetime prediction data (described later) stored in memory 46 (in other words, on the basis of the photosensor log or the light source control log). Maintenance simulator app 42 outputs a summary file and an individual file (described later) as maintenance data indicating the updated timing for maintenance.

Light source lifetime predictor app 44 predicts the lifetime of light source unit 14 in projector 4, on the basis of the latest value of the photosensor log or the latest value of the light source control log stored in memory 46. Light source lifetime predictor app 44 stores light source lifetime prediction data indicating the predicted lifetime of light source unit 14 in memory 46.

### 2. Operation of Maintenance System

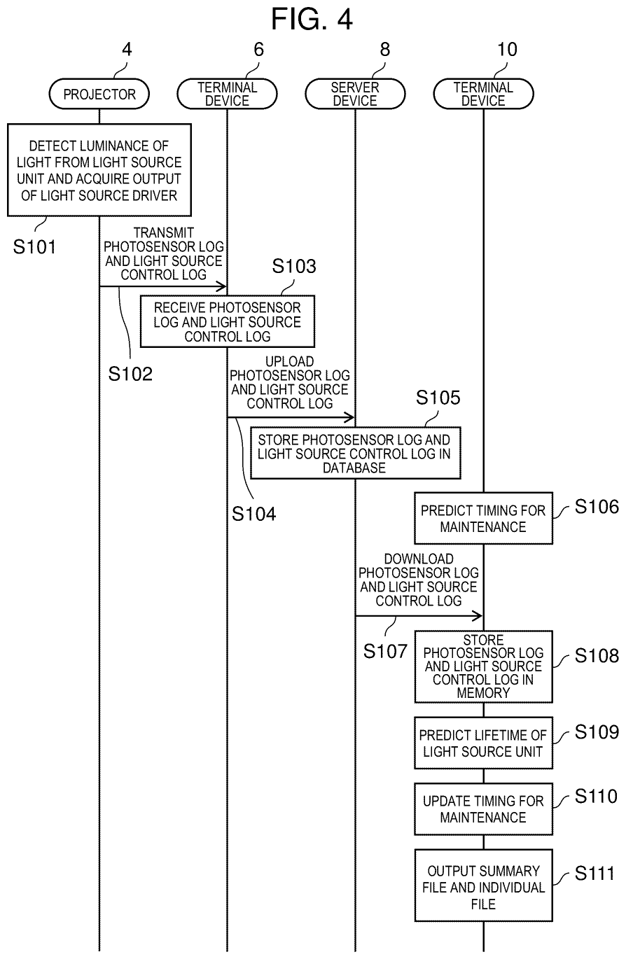

An operation of maintenance system 2 according to the exemplary embodiment will now be described with reference to FIG. 4. FIG. 4 is a sequence chart illustrating the sequence of an operation of maintenance system 2 according to the exemplary embodiment.

As illustrated in FIG. 4, photosensor 18 in projector 4 detects the luminance of the light from light source unit 14, and microcomputer 22 acquires the output of light source driver 20 (S101). Microcomputer 22 in projector 4 acquires the photosensor log from photosensor 18 and the light source control log from the light source driver 20, and transmits the acquired photosensor log and light source control log to terminal device 6, via the network (S102).

Monitoring app 28 on terminal device 6 receives the photosensor log and the light source control log from projector 4 (S103), and uploads the received photosensor log and light source control log to server device 8 via internet 26 (S104).

Web server 34 on server device 8 receives the photosensor log and the light source control log from terminal device 6, and stores the received photosensor log and light source control log in database 36 (S105).

Maintenance simulator app 42 on terminal device 10 predicts timing for maintenance of projector 4, by running a simulation on the basis of at least one of a temporal change in the output of light source unit 14 or a usage condition of projector 4, entered by an employee or the like of managed service provider 38 (S106). For example, maintenance simulator app 42 predicts that the timing for replacing light source unit 14 is “Jun. 1, 2023”, as the timing for maintenance of projector 4.

Web browser 40 on terminal device 10 downloads the photosensor log and the light source control log from server device 8 via internet 26 (S107), and stores the downloaded photosensor log and light source control log in memory 46 (S108).

Light source lifetime predictor app 44 on terminal device 10 predicts the lifetime of light source unit 14 in projector 4, on the basis of the latest value of the photosensor log or the latest value of the light source control log stored in memory 46 (S109).

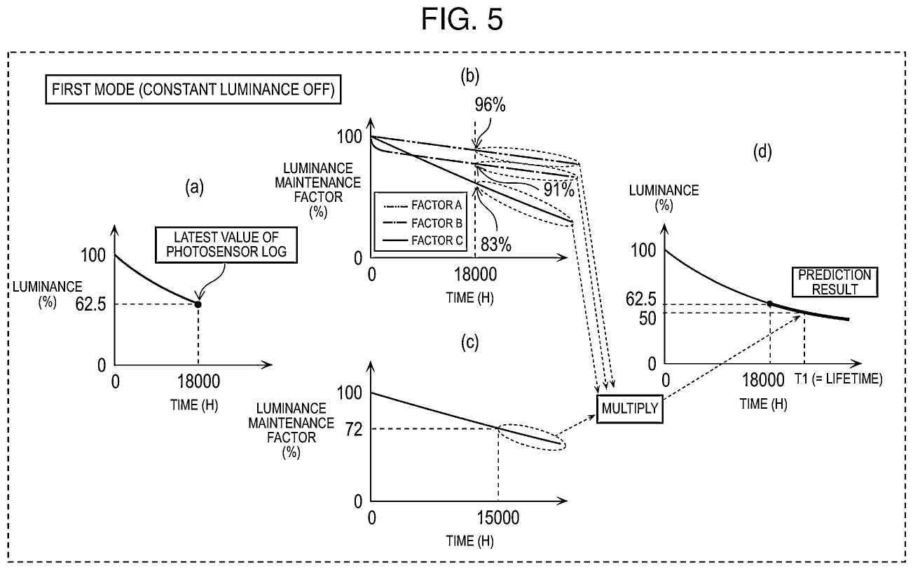

A method for predicting the lifetime of light source unit 14 when projector 4 is switched to the first mode will now be described with reference to FIG. 5.

Part (a) of FIG. 5 is a graph illustrating a temporal change in the luminance of the light from light source unit 14 in the first mode. The horizontal axis of the graph in part (a) of FIG. 5 represents the time for which light source unit 14 has been put in use, and the vertical axis of the graph represents a value in the photosensor log (actual measurement).

Part (b) of FIG. 5 is a graph of the degree of deterioration of light source unit 14 according to the present exemplary embodiment, with the degree of deterioration broken down into factors of the external condition representing the environmental conditions of projector 4, among the usage conditions of projector 4. The three graphs representing the degree of deterioration of light source unit 14 in part (b) of FIG. 5 include: a graph based on factor A attributable to the dust attached to component A of light source unit 14 in projector 4; a graph based on factor B attributable to the dust attached to component B of light source unit 14; and a graph based on factor C attributable to other internal dust in projector 4. The horizontal axis of the graph in part (b) of FIG. 5 represents the time for which light source unit 14 has been put in use, and the vertical axis of the graph represents the luminance maintenance factor (theoretical value) of light source unit 14. Note that data representing the graph in part (b) of FIG. 5 (hereinafter, referred to as “first deterioration data”) is stored in advance in memory 46 included in terminal device 10.

Part (c) of FIG. 5 is a graph indicating the degree of deterioration of light source unit 14, the deterioration attributable to factor D that is the unique condition representing the time of use and the output setting of the light source, among the usage conditions of projector 4. The horizontal axis of the graph in part (c) of FIG. 5 represents the time for which light source unit 14 has been put in use, and the vertical axis of the graph represents the luminance maintenance factor (theoretical value) of light source unit 14. Note that data representing the graph in part (c) of FIG. 5 (hereinafter, referred to as “second deterioration data”) is stored in advance in memory 46 included in terminal device 10.

Part (d) of FIG. 5 is a graph (light source lifetime prediction data) obtained by adding a prediction result of the lifetime of light source unit 14 to the graph of part (a) of FIG. 5.

As indicated in part (a) of FIG. 5, in the first mode, the luminance of the light from light source unit 14 drops gradually from 100% due to the aging of light source unit 14, and is 62.5% at present (18,000 hours). In other words, the latest value of the photosensor log is 62.5%. Note that the output of light source driver 20 is kept constant at 100%. In this case, the luminance maintenance factor of light source unit 14 over 18,000 hours is 62.5% (=62.5%/100%).

Light source lifetime predictor app 44 reads the latest value “62.5%” of the photosensor log from memory 46. Next, light source lifetime predictor app 44 reads the first deterioration data from memory 46, to read a luminance maintenance factor of 96% as a deterioration of light source unit 14 based on factor A, a luminance maintenance factor of 91% as a deterioration of light source unit 14 based on factor B, and a luminance maintenance factor of 83% as a deterioration of light source unit 14 based on factor C, all of which correspond to 18,000 hours, as illustrated in part (b) of FIG. 5.

Light source lifetime predictor app 44 then calculates a luminance maintenance factor of 72% (=62.5%/(96%×91%×83%)), as the degree of deterioration of light source unit 14 based on the factor D, using the luminance maintenance factors 96%, 91%, and 83% and 62.5% that are the latest values of the photosensor log read as described above. Light source lifetime predictor app 44 then reads the second deterioration data from memory 46, and reads the time corresponding to the luminance maintenance factor of 72% (15,000 hours) as illustrated in part (c) of FIG. 5. At this time, light source lifetime predictor app 44 performs what is called a time shift, in which 15,000 hours in the graph in part (c) of FIG. 5 is handled as 18,000 hours. Light source lifetime predictor app 44 then generates the graph illustrated in part (d) of FIG. 5, as the light source lifetime prediction data, by multiplying the part subsequent to 18,000 hours in the graph of part (b) of FIG. 5, with the part subsequent to 15,000 hours in the graph of part (c) of FIG. 5, and connecting the resultant graph to the graph indicated in part (a) of FIG. 5.

The part plotted in the thick line in the graph in part (d) of FIG. 5 corresponds to the prediction result. Light source lifetime predictor app 44 predicts time T1 (for example, 20,000 hours) corresponding to the luminance of 50%, in the graph in part (d) of FIG. 5, as the end of the lifetime of light source unit 14.

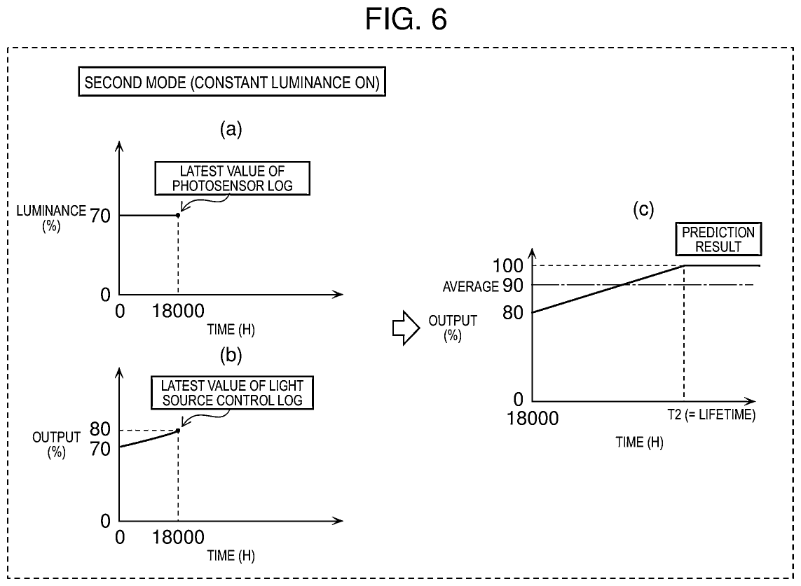

A method for predicting the lifetime of light source unit 14 when projector 4 is switched to the second mode will now be described with reference to FIG. 6.

Part (a) of FIG. 6 is a graph illustrating a temporal change in the luminance of the light from light source unit 14 in the second mode. The horizontal axis of the graph in part (a) of FIG. 6 represents the time for which light source unit 14 has been put in use, and the vertical axis of the graph represents a value in the photosensor log (actual measurement).

Part (b) of FIG. 6 is a graph illustrating a temporal change in the output of light source driver 20, in the second mode. The horizontal axis of the graph in part (b) of FIG. 6 represents the time for which light source unit 14 has been put in use, and the vertical axis of the graph represents a value in the light source control log (actual measurement).

Part (c) of FIG. 6 is a graph (light source lifetime prediction data) indicating a result of predicting the lifetime of light source unit 14.

In the second mode, the luminance of the light from light source unit 14 is sustained at 70%, as indicated in part (a) of FIG. 6, while the output of light source driver 20 is gradually increased from 70% to 80% at present (18,000 hours), as indicated in part (b) of FIG. 6. In other words, the latest value of the photosensor log is 70%, and the latest value of the light source control log is 80%.

Light source lifetime predictor app 44 reads “80%” that is the latest value of the light source control log from memory 46. Light source lifetime predictor app 44 then reads prediction data of the lifetime of light source unit 14, at the point corresponding to the latest value of the light source control log. The prediction of the output of light source driver 20 increases from 80% to 100%, and then saturates at 100%, as indicated by the graph in the solid line in part (c) of FIG. 6. In other words, the timing at which the prediction saturates at 100% is determined as the timing of the end of lifetime of light source unit 14.

Described in the present exemplary embodiment is an example of a graph of data representing a prediction of the lifetime of light source unit 14, as indicated in part (c) of FIG. 6, with 80% as the latest value in the light source control log; however, memory 46 has a plurality of different graphs corresponding to the respective latest values of the light source control log, and a different graph is referred to depending on the latest value in the light source control log. In other words, time T2 at which the output of light source driver 20 saturates at 100% changes depending on the latest value in the light source control log.

Referring back to FIG. 4, after step S109, light source lifetime predictor app 44 stores the light source lifetime prediction data generated as described above, in memory 46. Maintenance simulator app 42 then updates the timing for maintenance, as predicted in step S106, on the basis of the light source lifetime prediction data stored in memory 46 (S110). For example, maintenance simulator app 42 updates the timing for replacing light source unit 14 from “Jun. 1, 2023” to “Jul. 3, 2023” as the timing for maintenance of projector 4.

Maintenance simulator app 42 then outputs a summary file and an individual file as the maintenance data including the updated timing for maintenance (S111). The output summary file and individual file are provided to a user who is a user of projector 4.

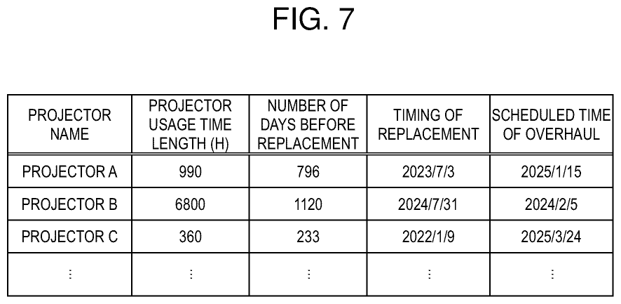

An example of the summary file will be described with reference to FIG. 7. FIG. 7 is a table illustrating an example of the summary file.

The summary file is data indicating the timings for maintenance for a plurality of projectors 4. As indicated in FIG. 7, the summary file is table data in which a projector name, the usage time length of the projector, the number of days before replacement, timing of replacement, and the scheduled time of overhaul are associated with one other.

In the example illustrated in FIG. 7, the first line of the summary file stores the name of a projector “projector A”, the usage time length of the projector “990 hours”, the number of days before replacement “796 days”, the timing of replacement “Jul. 3, 2023”, and the timing of scheduled overhaul “Jan. 15, 2025”. Note that projector A corresponds to projector 4 illustrated in FIG. 1, and the timing of replacement “Jul. 3, 2023” in the summary file corresponds to the timing for maintenance updated in step S110 described above.

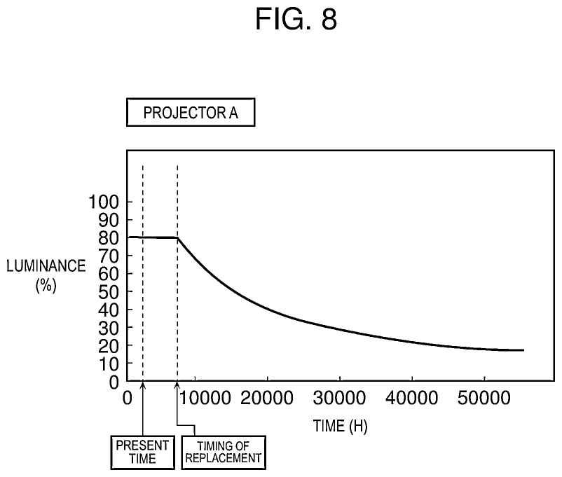

An example of the individual file will be described with reference to FIG. 8. FIG. 8 is a diagram illustrating an example of an individual file.

The individual file is data indicating the timing for maintenance for one projector 4. As illustrated in FIG. 8, the individual file is a graph illustrating a result of a predicted temporal change in the luminance of the light output from light source unit 14. In the individual file illustrated in FIG. 8, a prediction is made, for “projector A” in the second mode, that the luminance remains constant at 80% up to 8,000 hours, and starts to drop at 8,000 hours. The prediction in the individual file illustrated in FIG. 8 indicates that the timing for replacing light source unit 14 is 8,000 hours at which the luminance starts to drop from 80%.

The user who is the user of projector 4 can replace light source unit 14 at an appropriate timing by accessing the summary file or the individual file provided thereto.

### 3. Advantageous Effect

In the present exemplary embodiment, the maintenance method is a maintenance method for projector 4 having light source unit 14. The maintenance method includes: (a) a step of predicting timing for maintenance for projector 4 based on at least one of a temporal change in the output of light source driver 20 or a usage condition of projector 4; (b) a step of detecting luminance of light output from light source unit 14; and (c) a step of updating the timing for maintenance predicted in (a), based on a detection result in (b).

With such a configuration, by updating the timing for maintenance based on the luminance detected in real time, the timing for maintenance can be predicted at a higher accuracy.

In the present exemplary embodiment, the maintenance method further includes (e) a step of outputting maintenance data indicating the timing for maintenance updated in the above (c).

Accordingly, based on the output maintenance data, projector 4 can be maintained at an appropriate timing.

Furthermore, in the present exemplary embodiment, projector 4 is a projector that projects light output from light source unit 14 onto a projection surface. Projector 4 is switchable between a first mode for controlling light source driver 20 to keep the output of light source driver 20 constant, and a second mode for controlling light source driver 20 to keep the luminance of light output from light source unit 14 constant. In the above (b), the luminance of light output from light source unit 14 and the output of light source driver 20 are detected. In the above (c), when projector 4 is switched to the first mode, the timing for maintenance predicted in the above (a) is updated based on the luminance detected in the above (b); and when projector 4 is switched to the second mode, the timing for maintenance predicted in the above (a) is updated based on the output of light source driver 20 detected in the above (b).

Accordingly, even with projector 4 switched either to the first mode or the second mode, the timing for maintenance can be updated appropriately.

### 4. Modifications

The following configurations may also be used, instead of the configuration according to the exemplary embodiment described above.

For example, projector 4 includes a plurality of components including light source unit 14. The maintenance method may further include (d) a step of determining timings of replacement of the plurality of components to be within a predetermined period, based on lifetime data indicating a lifetime of each of the plurality of components.

With this, for example, when the lifetime data indicates the lifetime of component A as “Jan. 15, 2023”, the lifetime of component B as “Mar. 20, 2023”, and the lifetime of component C as “Apr. 10, 2023”, the timings of replacing component A, component B, and component C can be determined to gather the timings of replacing component A, component B, and component C within a predetermined period “Jan. 1, 2023 to January 31”. As a result, component A, component B, and component C can be replaced altogether in the predetermined period.

In the above (b), brightness of the projection surface may be detected as the luminance of the light output from light source unit 14.

With this, it is possible to further improve the accuracy of the prediction of the timing for maintenance taking not only the internal factors of projector 4 but also external factors of projector 4 into consideration.

The maintenance method further includes (f) a step of correcting at least one of the output of light source driver 20 or a gamma value of projector 4, based on the brightness of the projection surface detected in the above (b).

With this, it is possible to make a deterioration in the luminance less visually recognizable.

### Modifications, Etc.

The exemplary embodiment has been described above, as an example of the technique disclosed in the present application. The technique according to the present disclosure is, however, not limited to the above exemplary embodiment, and is also applicable to other exemplary embodiments with an appropriate modification, replacement, addition, omission, or the like made thereto. The components described in the above exemplary embodiment may also be combined to form an additional exemplary embodiment.

As such, other exemplary embodiments will be described below as some examples.

In the exemplary embodiment described above, the device is described as projector 4, but the present invention is not limited thereto, and the device may be any device including a light source.

In the exemplary embodiment described above, each of the components may be implemented by a piece of dedicated hardware or may be achieved by executing a software program suitable for the component. The components may be implemented by causing a program-execution unit, such as a CPU or a processor, to read and to execute a software program stored in a recording medium, such as a hard disk or a semiconductor memory.

Furthermore, some or all of the functions of terminal device 10 according the exemplary embodiment may also be implemented by causing a processor such as a CPU to execute a program.

As described above, the exemplary embodiment has been described as an example of the technique according to the present disclosure. For this purpose, the accompanying drawings and the detailed descriptions have been provided.

Thus, the components illustrated in the accompanying drawings and described in the detailed description may include not only the components essential for solving the problem, but also components that are not essential for solving the problem, as illustrative examples of the technique described above. For this reason, it should not be immediately construed that those non-essential components are essential, only on the basis of the fact that those non-essential components are illustrated in the accompanying drawings or described in the detailed description.

Because the above described exemplary embodiments are intended to exemplify the technique according to the present disclosure, various modifications, replacements, additions, and omissions may be made within the scope of the appended claims or equivalent thereof.

The present disclosure is applicable as a maintenance method for a projector used in a museum or an amusement park, for example.

What is claimed is:

1. A maintenance method for a device including a light source, the maintenance method comprising:
(a) a step of predicting timing for maintenance for the device based on at least one of a temporal change in an output of the light source or a usage condition of the device;
(b) a step of detecting luminance of light output from the light source; and
(c) a step of updating the timing for maintenance predicted in (a), based on a detection result in (b).

2. The maintenance method according to claim 1, wherein
the device includes a plurality of components including the light source, and
the maintenance method further includes
(d) a step of determining timings of replacement of the plurality of components to be within a predetermined period, based on lifetime data indicating a lifetime of each of the plurality of components.

3. The maintenance method according to claim 1, further comprising
(e) a step of outputting maintenance data indicating the timing for maintenance updated in (c).

4. The maintenance method according to claim 1, wherein
the device is a projector that projects light output from the light source onto a projection surface,
the projector is switchable between a first mode for controlling the light source to keep the output of the light source constant and a second mode for controlling the light source to keep the luminance of light output from the light source constant,
in (b), the luminance of light output from the light source and the output of the light source are detected,
in (c),
when the projector is switched to the first mode, the timing for maintenance predicted in (a) is updated based on the luminance detected in (b), and
when the projector is switched to the second mode, the timing for maintenance predicted in (a) is updated based on the output of the light source detected in (b).

5. The maintenance method according to claim 4, wherein brightness of the projection surface is detected in (b), as the luminance of the light output from the light source.

6. The maintenance method according to claim 5, further comprising
(f) a step of correcting at least one of the output of the light source or a gamma value of the projector, based on the brightness of the projection surface detected in (b).
